(19) United States
(12) Patent Application Publication
(10) Pub. No.: US 2019/0203164 A1
(43) Pub. Date: Jul. 4, 2019

(54) REMOVAL OF SULFITES/HISTAMINES FROM PRESSURIZED BEVERAGE FLOW

(71) Applicant: Coravin, Inc., Burlington, MA (US)

(72) Inventors: Michael Rider, Lowell, MA (US); Sarah Deslandes, Boston, MA (US)

(73) Assignee: Coravin, Inc., Burlington, MA (US)

(21) Appl. No.: 16/218,854

(22) Filed: Dec. 13, 2018

Related U.S. Application Data
(60) Provisional application No. 62/611,943, filed on Dec. 29, 2017.

(51) Int. Cl. C12H 1/04; B01D 15/36; B01D 24/02; B01D 29/00; B67D 1/00; B67D 1/04; C12H 1/052

(52) U.S. Cl. CPC C12H 1/0432; B01D 15/361; B01D 24/02; B01D 29/0018; B01D 2257/70; B67D 1/0412; C12H 1/0416; B01D 2221/02; B01D 2257/302; B67D 1/0004

(57) ABSTRACT

A removal nozzle may be used with a pressurized beverage dispenser to remove histamines and/or sulfites from a beverage as it is dispensed under pressure. A nozzle housing may be engaged with the outlet of a beverage dispenser, such as one that inserts a needle into a container to extract beverage from the container by injecting pressurized gas.

### RELATED APPLICATION

This application claims priority under 35 U.S.C. § 119(e) to U.S. Provisional Application Ser. No. 62/611,943, filed Dec. 29, 2017, which is herein incorporated by reference in its entirety.

### BACKGROUND OF INVENTION

This invention relates generally to the dispensing or other extraction of fluids from within a container, e.g., the dispensing of wine from a wine bottle.

### SUMMARY OF INVENTION

One or more embodiments in accordance with aspects of the invention allow a user to dispense or otherwise extract a beverage, such as wine, from within a bottle that is sealed by a cork, plug, elastomeric septum or other closure without removing the closure. In some cases, removal of liquid from such a bottle may be performed one or more times, yet the closure may remain in place during and after each beverage extraction to maintain a seal for the bottle. Thus, the beverage may be dispensed from the bottle multiple times and stored for extended periods between each extraction with little or no effect on beverage quality. In some embodiments, little or no gas, such as air, which is reactive with the beverage may be introduced into the bottle either during or after extraction of beverage from within the bottle. Thus, in some embodiments, a user may withdraw wine from a wine bottle without removal of, or damage to, the cork, and without allowing air or other potentially damaging gasses or liquids entry into the bottle.

Some beverages, such as wines and other alcoholic beverages, contain sulfites and/or histamines that are produced in or otherwise picked up by the beverage during fermentation, aging or other processes. Since some people are sensitive or otherwise react to these compounds, it can be beneficial to remove or otherwise reduce their presence in a beverage.

In one illustrative embodiment, a beverage dispensing device includes a conduit arranged to provide a flow of beverage under pressure to a distal end of the conduit. The conduit may be arranged as a tube or other structure that conducts flow of the beverage. A nozzle housing having an inlet may be fluidly coupled to the distal end of the conduit and a flowpath of the housing may extend from the inlet. The housing may engage the conduit by a friction fit, e.g., a seal of the housing may engage the conduit to provide a fluid seal and physical connection, although other arrangements such as a threaded engagement are possible. The housing may contain a removal material that is arranged to remove or otherwise reduce the presence of histamines and/or sulfites from a flow of pressurized beverage, such as wine, through the removal material. After passage through the removal material, the beverage may be dispensed. In some cases, the removal material may be contained in a cartridge that can be replaced, e.g., by opening the housing and replacing a cartridge held inside the housing. In other embodiments, the housing and its removal material may be used to dispense a certain number of beverages, or a volume of beverage, and the entire housing and its removal material may be replaced for subsequent dispensing.

In some embodiments wine that is dispensed so that not only are histamines and/or sulfites reduce, the beverage may be aerated as well. For example, the beverage may be dispensed from the housing in multiple jets that have a relatively high surface area to cross-sectional area ratio so as to permit ambient air to be dissolved in or otherwise interact with the beverage. Such interaction between wine and air is desirable in certain instances, and an aeration device may speed air/wine interaction that would otherwise occur. Such aeration may also aid in reducing the presence of histamines and/or sulfites as well.

Various exemplary embodiments of the device are further depicted and described below.

### BRIEF DESCRIPTION OF THE DRAWINGS

Aspects of the invention are described with reference to various embodiments, and to the figures, which include:

FIG. 1 shows a sectional side view of a beverage extraction device in preparation for introducing a needle through a closure of a beverage bottle;

FIG. 2 shows the FIG. 1 embodiment with the needle passed through the closure;

FIG. 3 shows the FIG. 1 embodiment while introducing gas into the bottle;

FIG. 4 shows the FIG. 1 embodiment while dispensing beverage from the bottle and employing a removal nozzle that contains a removal material;

FIG. 5 shows a sectional side view of a removal nozzle in an illustrative embodiment;

FIG. 6 shows a front view of the removal nozzle of FIG. 5;

FIG. 7 shows a rear perspective view the removal nozzle of FIG. 5; and

FIG. 8 shows an embodiment in which a removal nozzle contains a replaceable cartridge.

### DETAILED DESCRIPTION

Aspects of the invention are described below with reference to illustrative embodiments, but it should be understood that aspects of the invention are not to be construed narrowly in view of the specific embodiments described. Thus, aspects of the invention are not limited to the embodiments described herein. For example, embodiments of a removal nozzle are described as used with a beverage extractor that inserts a needle through a container closure to inject gas into the container and conduct pressurized beverage from the container. However, removal nozzles are not limited to such applications, and may be used with any type of beverage dispenser. For example, a beverage dispenser need not use a needle that is inserted through a cork, but may instead employ a conduit that is passed through a bottle opening after the cork is removed. This is but one alternative, and other dispensing arrangements may be used with a removal nozzle. It should also be understood that various aspects of the invention may be used alone and/or in any suitable combination with each other, and thus various embodiments should not be interpreted as requiring any particular combination or combinations of features. Instead, one or more features of the embodiments described may be combined with any other suitable features of other embodiments.

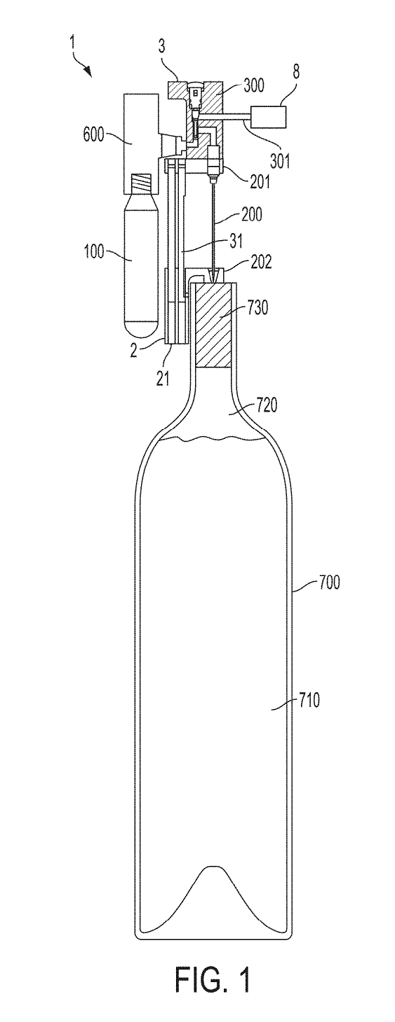

FIGS. 1-4 show schematic views of one embodiment of a beverage extraction device (or extractor) 1 that may be used in one or more aspects of the invention. This illustrative device 1 includes a body 3 with an attached pressurized source of gas 100 (such as a compressed gas cylinder) that provides gas under pressure (e.g., 2600 psi or less as dispensed from the cylinder) to a regulator 600. In this arrangement, the cylinder 100 is secured to the body 3 and regulator 600 by a threaded connection, although other configurations are possible, such as those described below and/or in U.S. Pat. Nos. 4,867,209; 5,020,395; and 5,163,909 which are hereby incorporated by reference with respect to their teachings regarding mechanisms for engaging a gas cylinder with a cylinder receiver. The regulator 600 is shown schematically and without detail, but can be any of a variety of commercially available or other single or multi-stage pressure regulators capable of regulating gas pressures to a pre-set or variable outlet pressure. The main function of the regulator 600 is to provide gas at a pressure and flow rate suitable for delivery to the bottle 700 (such as a wine bottle), e.g., so that a pressure established inside the bottle 700 does not exceed a desired level. In other embodiments, no pressure regulation of the gas released from the cylinder 100 need be done, and instead, unregulated gas pressure may be delivered to the bottle 700. In still further embodiments, a flow restrictor such as one or more small orifices or narrow diameter tubes may be used to reduce the pressure from the cylinder 100 rather than a regulator.

In this embodiment, the body 3 also includes a valve 300 operable to control the flow of gas from the regulator 600. The valve 300 may be a 3-way toggle valve that includes a single operation button and functions to selectively introduce pressurized gas into the bottle 700 and extract beverage 710 (such as wine) from the bottle 700 via a needle 200. Details regarding the operation of such a valve 300 are provided in U.S. Pat. No. 8,225,959, which is incorporated by reference in its entirety. Of course, other valve arrangements for controlling pressurized gas and beverage flow are possible. For example, the 3-way valve 300 could be replaced with a pair of on/off valves, one for controlling gas introduction to the bottle 700, and another for controlling flow of beverage from the bottle 700. Each valve could have its own actuator, allowing a user to selectively open and close the valves, whether individually or simultaneously. In short, details regarding the operation of the regulator 600 and valve 300 or other mechanisms for introducing gas into a bottle, and removing beverage from the bottle 700 are not necessarily limitations on aspects of the invention and may be modified as suitable.

To introduce gas into the bottle 700 and extract beverage, a needle 200 attached to the body 3 is inserted through a cork or other closure 730 that seals an opening at a neck of the bottle 700. This illustrative device 1 uses a pencil-tip non-coring needle 200 with a needle opening 220 along a sidewall of the needle near the needle tip. While the needle 200 may be inserted into the cork or other closure 730 in different ways, in this embodiment, the device 1 includes a base 2 with a pair of channels 21 that receive and guide movement of respective rails 31 of the body 3. Thus, movement of the body 3 and attached needle 200 relative to the bottle closure 730 may be guided by the base 2, e.g., the body 3 may slide relative to the base 2 to move the needle 200 into/out of the closure 730. In addition, movement of the needle 200 may be guided by a needle guide 202 that is attached to the base 2 and positioned over the closure 730. Other arrangements for guiding movement of the body 3 relative to the base 2 are possible, such as providing one or more rails on the base 2 which engage with a channel or other receiver of the body 3, providing an elongated slot, channel or groove on the body or base which engages with a corresponding feature (e.g., a tab) on the other of the body or base and allows for sliding movement, a linkage that connects the body and base together and allows for movement of the body to insert the needle into the closure, and others. Alternatively, the needle could be inserted without guidance, but rather by the hand of the user through the cork.

In some embodiments, the base 2 may be fixed or otherwise held in place relative to the bottle 700, e.g., by a clamp arm, sleeve, strap or other device that engages with the bottle 700. By restraining movement of the base 2 relative to the bottle 700, such an arrangement may help guide motion of a needle 200 relative to the bottle 700 when penetrating a closure 730, or when being withdrawn from the closure 730. Alternately, the bottle 700 may be manipulated by grasping and manipulating the device 1 since the clamp engaging the device 1 to the bottle 700 may securely hold the device 1 and bottle 700 together.

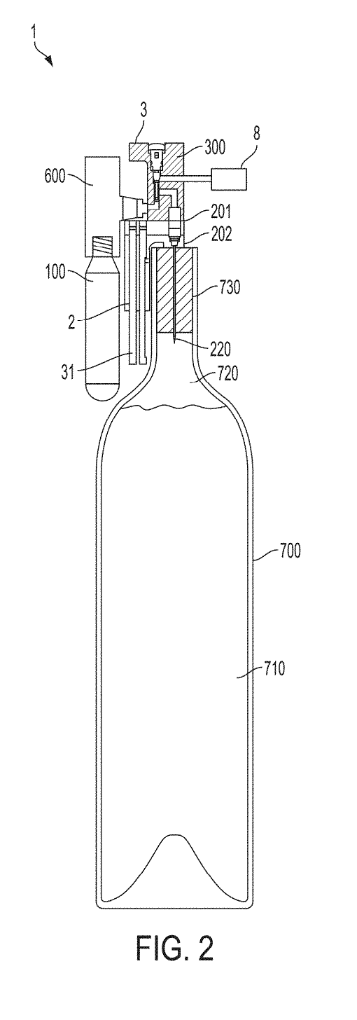

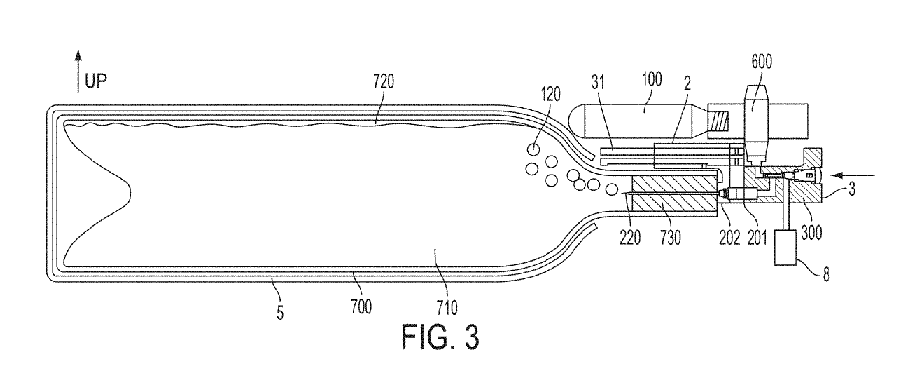

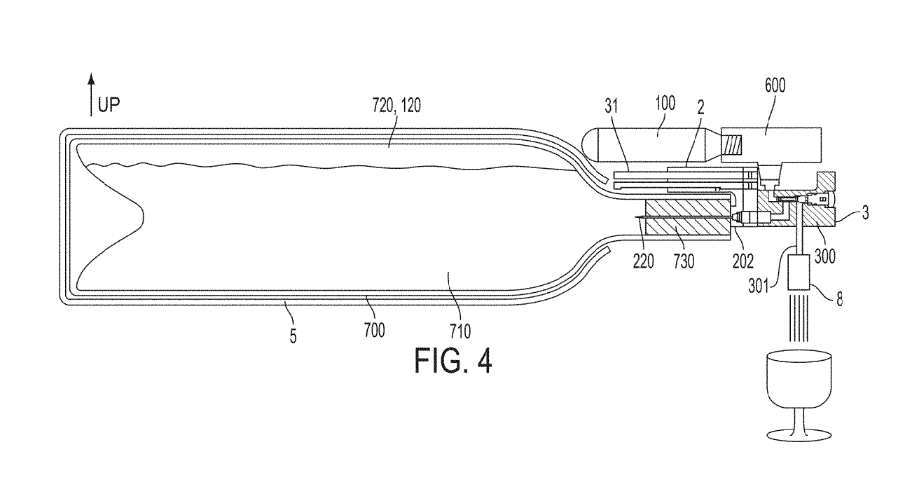

To insert the needle 200 through the closure 730, a user may push downwardly on the body 3 while maintaining the base 2 and the bottle 700 at least somewhat stationary relative to each other. The needle 200 will pass through the closure 730, guided in its motion, at least in part, by the guided motion of the body 3 relative to the base 2 (e.g., by the rails 31 and channels 21). With the needle 200 suitably inserted as shown in FIG. 2, a needle opening 220 at the needle tip may be positioned below the closure 730 and within the enclosed space of the bottle 700. The bottle 700 may then be tilted, e.g., so that the beverage 710 flows to near the closure 730 and any air or other gas 720 in the bottle 700 flows away from the closure. Pressurized gas 120 may then be introduced into the bottle 700 by actuating the valve 300 and causing gas from the cylinder 100 to flow through the valve 300 and needle 200 to exit at the needle opening 220, as shown in FIG. 3. Alternately, pressurized gas 120 can be introduced into the bottle 700 prior to tilting of the bottle, followed by tilting and dispensing of beverage. Thereafter, the valve 300 may be operated to stop the flow of pressurized gas and allow beverage 710 to flow into the needle opening 220 and through the needle 200 to be dispensed from the valve 300, as shown in FIG. 4.

As discussed above, in one aspect of the invention, beverage may be dispensed using a removal nozzle, such as a device that dispenses beverage so as to remove or otherwise reduce the presence of histamines and/or sulfites in the beverage. In some embodiments, the removal nozzle may also help aerate the beverage, i.e., expose a relatively large surface area per unit volume of beverage to ambient air or other gas and/or a device that actively mixes air or other gas with beverage in the dispensing process. For example, some wines are believed to improve in taste or other characteristics with suitable exposure to air after opening the wine bottle. As used herein, aeration refers to exposure of a beverage to air or other gas (carbon dioxide, oxygen, nitrogen, mixtures of gases, etc.) in such a way that gas reacts in some way with at least portions of the beverage and/or that gas is dissolved in the beverage and/or that gas or other compounds are released from the beverage to the air or other ambient gas environment.

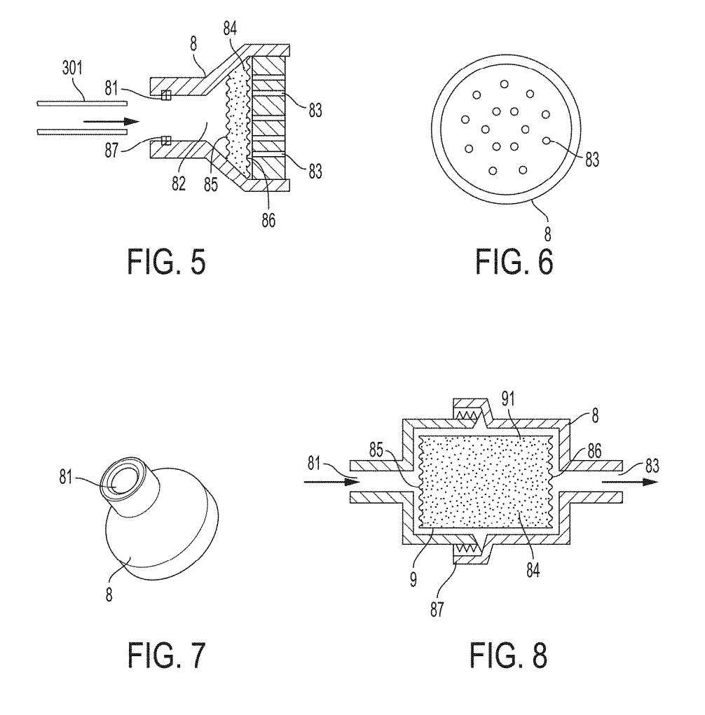

In the illustrative embodiment of FIGS. 1-4, wine is dispensed from the extraction device 1 via a nozzle housing 8 that receives pressurized wine from a dispensing conduit 301 and outputs wine into a user's cup or other vessel. The nozzle housing 8 may be arranged to receive wine at a relatively high pressure and output the wine after histamines and/or sulfites have been reduced. FIG. 5 shows a cross-sectional side view and FIG. 6 a front view of a nozzle housing 8 that may be used with an extraction device 1 like that in FIGS. 1-4 or other beverage dispensers. In this embodiment, the nozzle housing 8 is arranged to be coupled to a dispensing conduit 301 arranged to provide a flow of beverage under pressure to a distal end of the conduit 301. In some cases, the conduit 301 may be arranged to dispense wine or other beverage directly to a user's cup without a nozzle housing 8. This may allow a user to dispense wine or other beverage without providing a histamine or sulfite removal function during dispensing. (Histamine and/or sulfite removal as used herein refers to complete removal of such compounds, as well as measurable reduction of such compounds in the beverage.) However, if such removal is desired, a nozzle housing 8 may be attached to the conduit 301.

In this embodiment, the nozzle housing 8 includes an inlet opening that defines an inlet 81 that is fluidly coupled to the distal end of the conduit 301. The nozzle inlet 81 may be coupled to the conduit 301 in different ways, such as by screw thread, interference or friction fit, a bayonet connection, leur-type connection, etc., but in this embodiment engages with the conduit 301 by a friction fit. A seal 87, such as an o-ring or other element, may be provided at the inlet 81 to provide a fluid seal between the housing 8 and the conduit 301, as well as to provide a frictional engagement between the housing 8 and the conduit 301. Alternatively, housing 8 may be at least partially comprised of an elastic material and inlet 81 may be of a slightly smaller diameter than conduit 301, therefore causing a seal between housing 8 and conduit 301 due to compression of housing 8 about conduit 301. Although the housing 8 is shown engaging an exterior of the conduit 301, the housing 8 may engage an interior of the conduit 301 or engage with a butt-type connection.

The nozzle housing 8 includes a flowpath 82 that extends from the inlet 81 to an outlet 83. In this embodiment, the flowpath 82 includes a portion with an increasing cross-sectional area in a direction from the inlet 81 to a plurality of flow channels that define the outlet 83. For example, the flowpath 82 may taper outwardly such that a portion nearer the inlet 81 has a smaller cross-sectional area than a portion nearer the plurality of flow channels at the outlet 83. This may decrease a flow speed and increase a pressure of beverage at a location where the beverage begins to flow through a removal material 84. In this embodiment, the removal material 84 is sandwiched between inlet and outlet screens 85, 86, e.g., because the removal material 84 may be granular and the inlet and outlet screens 85, 86 may help keep the removal material 84 in place. While such screens 85, 86 are not necessary, the screens 85, 86 or other similar element may perform a filtering function, e.g., to remove particles over a threshold size from the dispensed beverage. For example, one or more of the screens 85, 86 or other filter structure may remove sediment or other particles from the dispensed beverage. A screen or other filter may include any suitable arrangement, such as a metal, plastic or other mesh, porous element, non-woven fibrous structure, and other filter arrangements. The removal material 84 may include any suitable compound or compounds, materials, etc., to reduce histamines and/or sulfites in a beverage such as wine. Such materials are known, such as ion exchange materials, oxidizers (such as hydrogen peroxide), and others. In short, any suitable removal material 84 may be employed to provide a desired level of histamine and/or sulfite level reduction. The removal material 84 may be provided in loose, granular form, a liquid form, a gas form, a solid block form, or combinations of such forms. For removal materials 84 in a liquid or gas form, other arrangements may be required to direct beverage through the material 84 than that shown in FIG. 5, e.g., a liquid removal material 84 may be held in a trap structure, similar to that used in plumbing applications, and beverage caused to flow through the trap. Alternately, the liquid or gaseous removal material 84 may be injected or otherwise introduced into a flow of beverage in a metered or other desired way, e.g., so the removal material 84 interacts with the beverage as needed.

After flowing through the removal material 84, the beverage may exit the housing via the outlet 83. In this illustrative embodiment, the outlet 83 includes a plurality of flow channels that serve to create multiple jets of beverage. In the embodiment of FIGS. 5 and 6, the flow channels 83 are formed as holes or openings through a plate arranged at the outlet of the nozzle housing 8, but other arrangements are possible. These jets may serve to aerate the beverage, if desired, which may also aid in histamine and/or sulfite removal. However, the beverage may be dispensed in other ways, such as by a single stream.

As will be understood, many removal materials 84 may only be capable of removing histamines and/or sulfites for a limited volume of beverage. The removal material 84 may be replaced, e.g., after being used to dispense a volume of beverage, or may be discarded and replaced by another removal nozzle housing 8 containing fresh removal material 84. FIG. 8 shows an illustrative embodiment in which removal material 84, again in solid, granular form, is contained in a replaceable cartridge 9. In this embodiment, the cartridge 9 includes a solid cylindrical sidewall 91 that is capped by inlet and outlet screens 85, 86 which may contain the removal material 84 and yet allow beverage to flow through the cartridge 9. As mentioned above, one or more of the screens 85, 86 or other filter structure may operate to filter the beverage as well, e.g., to remove particles over a threshold size from the dispensed beverage. The cartridge 9 may be replaced by opening the housing 8, e.g., by unscrewing inlet and outlet portions of the housing 8 by a threaded connection 87. Of course, the housing 8 may be made openable in other ways, such as by having housing sections engaged by friction fit, snap fit, adhesive, and others. With the cartridge 9 replaced, the removal housing 8 may be again engaged with a dispensing conduit 301 to receive a flow of pressurized beverage through the cartridge 9.

While aspects of the invention have been shown and described with reference to illustrative embodiments, it will be understood by those skilled in the art that various changes in form and details may be made therein without departing from the scope of the invention encompassed by the appended claims.

1. A beverage dispensing device, comprising:
a dispensing conduit arranged to provide a flow of beverage under pressure to a distal end of the conduit;
a housing having an inlet fluidly coupled to the distal end of the dispensing conduit and a flowpath extending from the inlet to an outlet; and
a histamine and/or sulfite removal material in flowpath of the housing and arranged to accommodate beverage flow under pressure through the removal material and to the outlet for dispensing, flow of the beverage through the removal material resulting in reduction of histamine and/or sulfite compounds in the beverage dispensed from the outlet.

2. The device of claim 1, wherein the housing includes a plurality of flow channels each having an inlet end fluidly coupled to the flowpath and extending to an outlet end, each of the plurality of flow channels arranged to receive pressurized beverage from the flowpath at the inlet end and to produce a jet of beverage at the outlet end so as to aerate the beverage.

3. The device of claim 1, wherein the removal material includes an ion exchange resin.

4. The device of claim 1, wherein the removal material is contained in a replaceable cartridge.

5. The device of claim 4, wherein the housing is openable to expose a chamber in which the cartridge is positioned.

6. The device of claim 1, wherein the housing and removal material are arranged to accommodate a flow of beverage under pressure of up to 30 psi.

7. The device of claim 1, further comprising:
a source of pressurized gas;
a needle fluidly coupled to the source of pressurized gas to pressurize a volume of beverage and provide the flow of beverage under pressure to the dispensing conduit.

8. The device of claim 1, wherein the removal material is arranged to remove histamines and/or sulfites from a pressurized flow of wine.
